(19) United States
(12) Patent Application Publication
(10) Pub. No.: US 2008/0168098 A1
(43) Pub. Date: Jul. 10, 2008

(54) System For Creating Interactive Video Advertisement

(76) Inventor: Joshua Paul, Porter Ranch, CA (US)

Correspondence Address: SUNG I. OH, PROFESSIONAL LAW CORPORATION, 710 QUAIL VALLEY LANE, WEST COVINA, CA, 91791, US

(21) Appl. No.: 11/969,863

(22) Filed: Jan. 4, 2008

Related U.S. Application Data
(60) Provisional application No. 60/879,092, filed on Jan. 4, 2007.

(51) Int. Cl. G06F 17/30

(52) U.S. Cl. 707/104.1; 707/E17.009

(57) ABSTRACT

A system creates interactive video advertisements, using elements provided by a client, and templates created using a node-based visual programming language. Client provided elements may include multimedia files, including but not limited to still images, text, and temporal files—such as video, music, and sound effects.

### RELATED APPLICATION

This application claims priority to a U.S. Provisional Application Ser. No. 60/879,092, filed Jan. 4, 2007, which is hereby incorporated by reference.

### BACKGROUND OF THE INVENTION

1. Field of the Invention

This invention is generally directed to a multimedia file creation. In particular, this invention is directed to template-based interactive multimedia file generation, using client supplied content.

2. Background of the Invention

With the exponential availability of video online, a tremendous opportunity exists for video commercials to be placed pre-roll, mid-roll, and post-roll in relation to individual viewings of such video. This opportunity is available to anyone with the knowledge or technical ability to produce a digital video, place it online, and purchase advertising placements. However, for many of the 24 million small businesses, 250 million eBay users, and numerous other parties who may have an item to sel—or otherwise inform people about—the technical hurdles may be too overwhelming. It is therefore beneficial to provide an easy-to-use, interactive video creation tool to enable individuals and businesses to take advantage of the opportunities of video advertising on the internet.

### INVENTION SUMMARY

A process that is capable of handling a request from client including selection of a template, the storage of the selection by an application, and a response from the application to client containing an outline of the necessary elements to fulfill the template. Further, a request containing the outlined elements from client may be processed. The application may provide a request to process the template for approval to a render grid using the client supplied elements. The grid may then render an audio-visual container using the template and client supplied elements. When the grid has finished the render, it may notify the application that it is complete. Moreover, the application may respond to the client with a preview of the result of the render. The client may either approve the render, or reject the render. Upon rejection of the render, the client may provide different elements for the application to process for approval. Upon approval client may provide different elements for the application to process for approval. Upon approval of the render by the client, the application may notify the grid to process the render for distribution. The application may additionally request payment from the client for the render. The grid may notify the application that the process for distribution is available. The client may also be notified of the URLs to access the completed render.

A system according to this invention creates interactive video advertisements, using elements provided by a client, and templates created using a node-based visual programming language. Client provided elements may include multimedia files, including but not limited to still images, text, audio, and temporal file—such as video, music, and sound effects. Upon receiving a set of elements, the application creates an audio-visual file by rendering it based on a high-quality template. The rendered audio-visual file provides an additional benefit of having an embedded hyperlink related to the provided content, which can also be used to track the effectiveness of the audio-visual file. This invention may use text-to-speech technologies to create voice-over audio tracks, a node-based visual programming language for template creation, and an embedded hyperlink for viewer interaction.

Other systems, methods, features, and advantages of the invention will be, or will become, apparent to one with skill in the art upon examination of the following figures and detailed description. It is intended that all such additional systems, methods, features, and advantages be included within this description, be within the scope of the invention, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a swimlane view of creating a multimedia file using client provided content;

FIG. 2 is a flowchart view of a creating a multimedia file using client provided images.

FIG. 3 is a flowchart view of a creating a variable duration multimedia file using client provided images.

FIG. 4 is a flowchart view of a creating a variable duration multimedia file using client provided images and an audio file created using client-provided text or audio.

FIG. 5 is a flowchart view of a creating a variable duration multimedia file using client provided images and an audio file created using client-provided text or audio and music.

FIG. 6 is a flowchart view of a creating a variable duration, hyperlinked multimedia file using client provided images and an audio file created using client-provided text or audio and music.

FIG. 7 is a flowchart view of a creating a watermarked, variable duration, hyperlinked multimedia file using client provided images and an audio file created using client-provided text or audio and music.

### DETAILED DESCRIPTION OF THE INVENTION

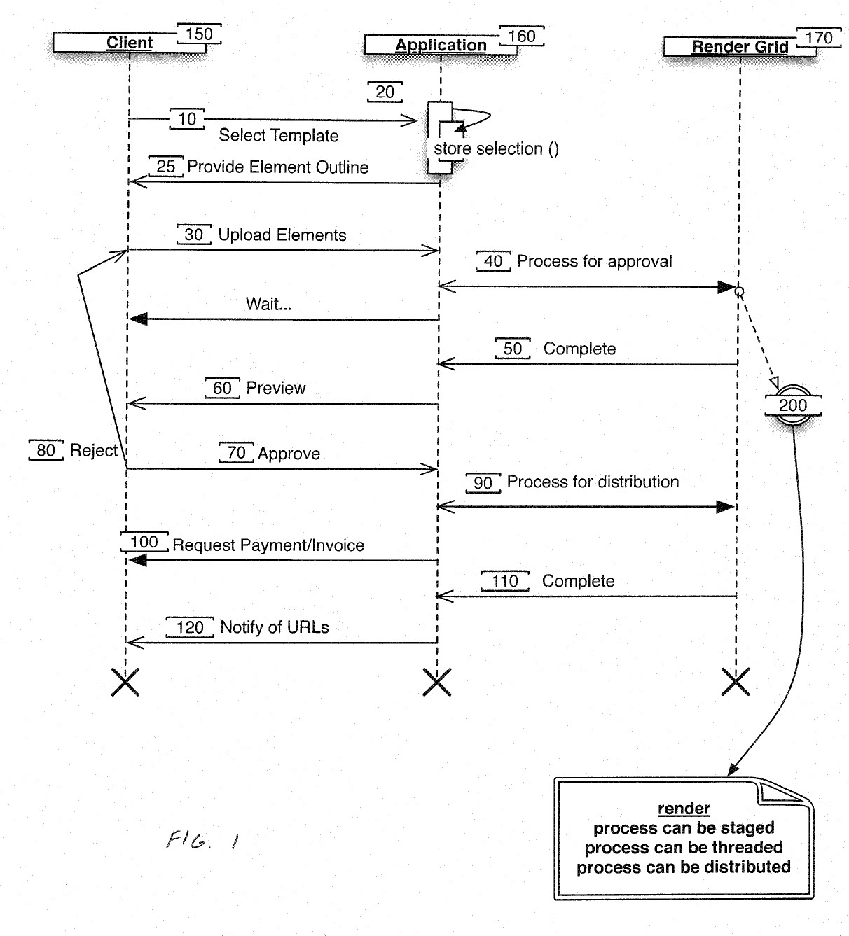

FIG. 1 shows a client 150, an application 160, a render grid 170, and a render 200. A request from client 150 includes a selection of a template 10, the storage 20 of selection 10 by application 160, and a response from application 160 to client 150 containing an outline of the necessary elements 25. There may be a request containing the outlined elements 30 from client 150. Application 160 provides a request to process for approval 40 to grid 170 with the template 10 using elements 30. The grid 170 may then render 200 an audio-visual container using template 10 and elements 30. When grid 170 has finished the render 200, it may notify application 160 with response complete 50. Moreover application 160 may respond to client 150 with preview 60 of the result of render 200. Client 150 can either approve 70 of render 200, or reject 80 of render 200. Upon rejection 80 of render 200, client 150 may provide different elements 30 for application 160 to process for approval 40. Upon approval 70 of render 200 by client 150, application 160 may notify grid 170 to process for distribution 90. Application 160 may additionally request payment 100 from client 150 for render 200. Grid 170 may notify application 160 that process for distribution 90 is available using a response complete 110. Client 150 may also be notified of the URLs 120 of the completed render 200.

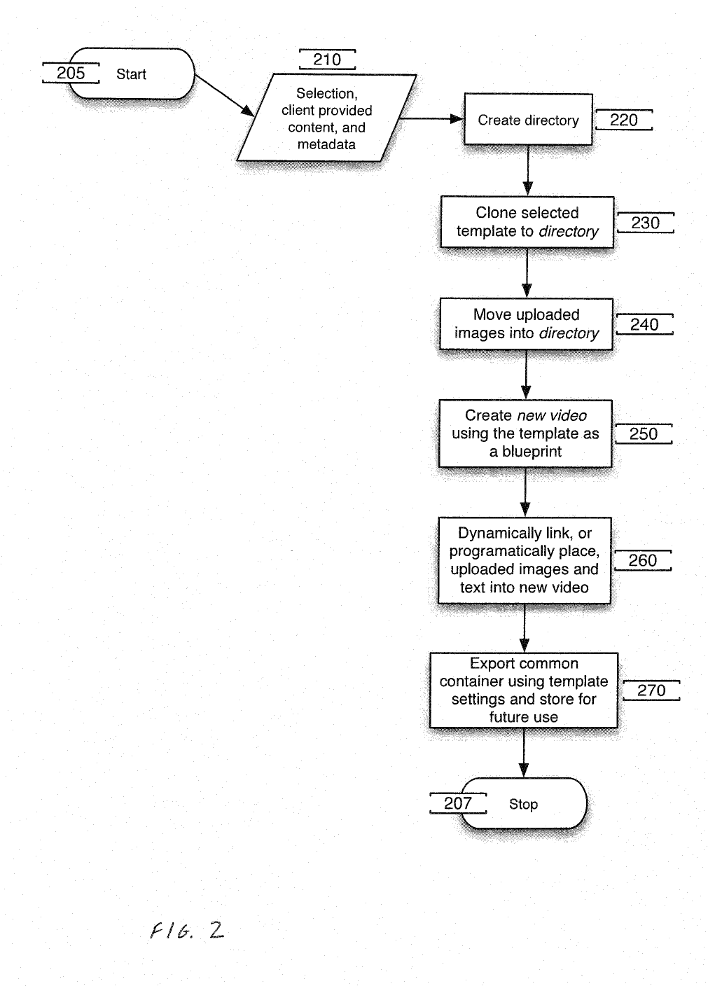

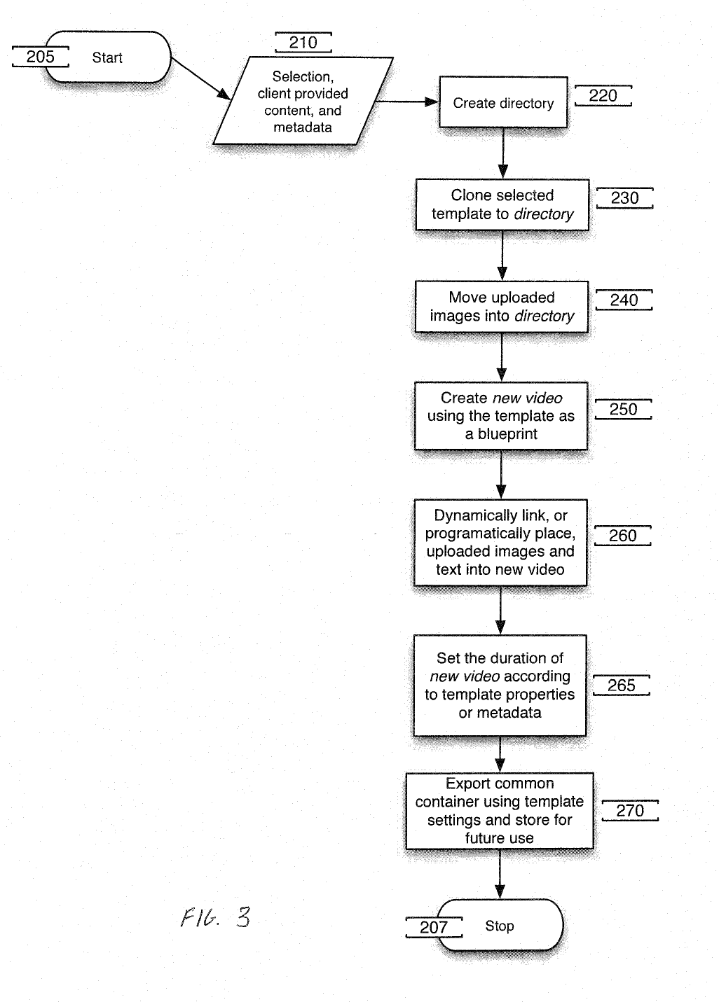

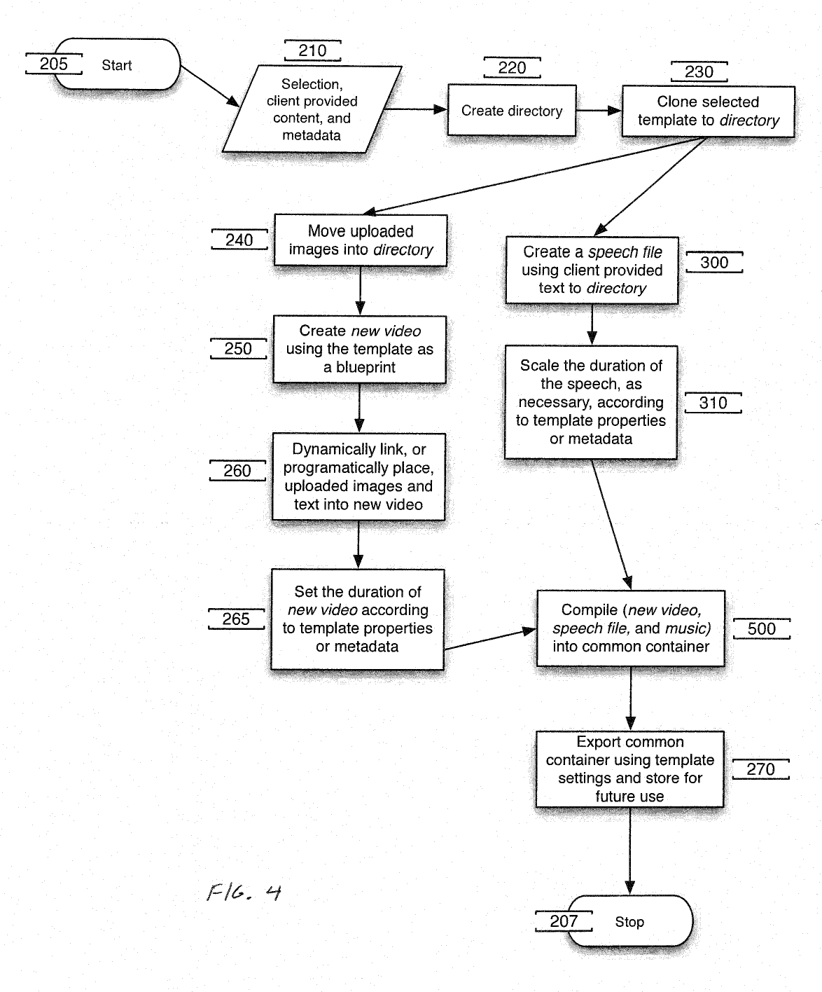

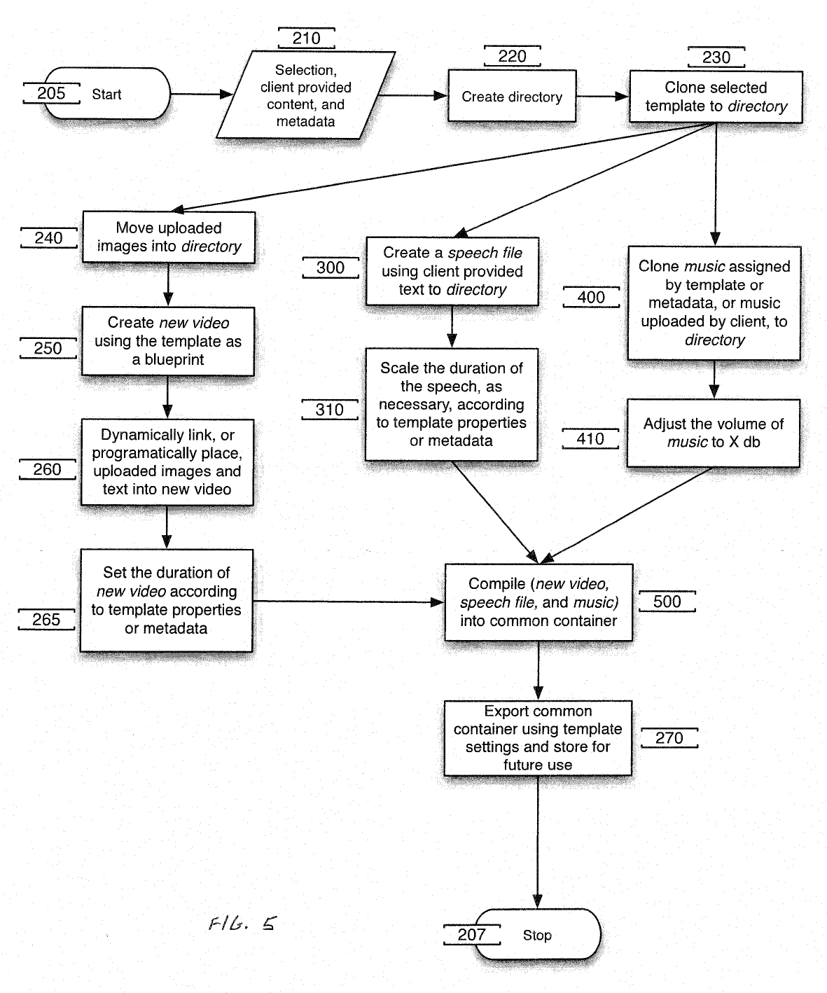

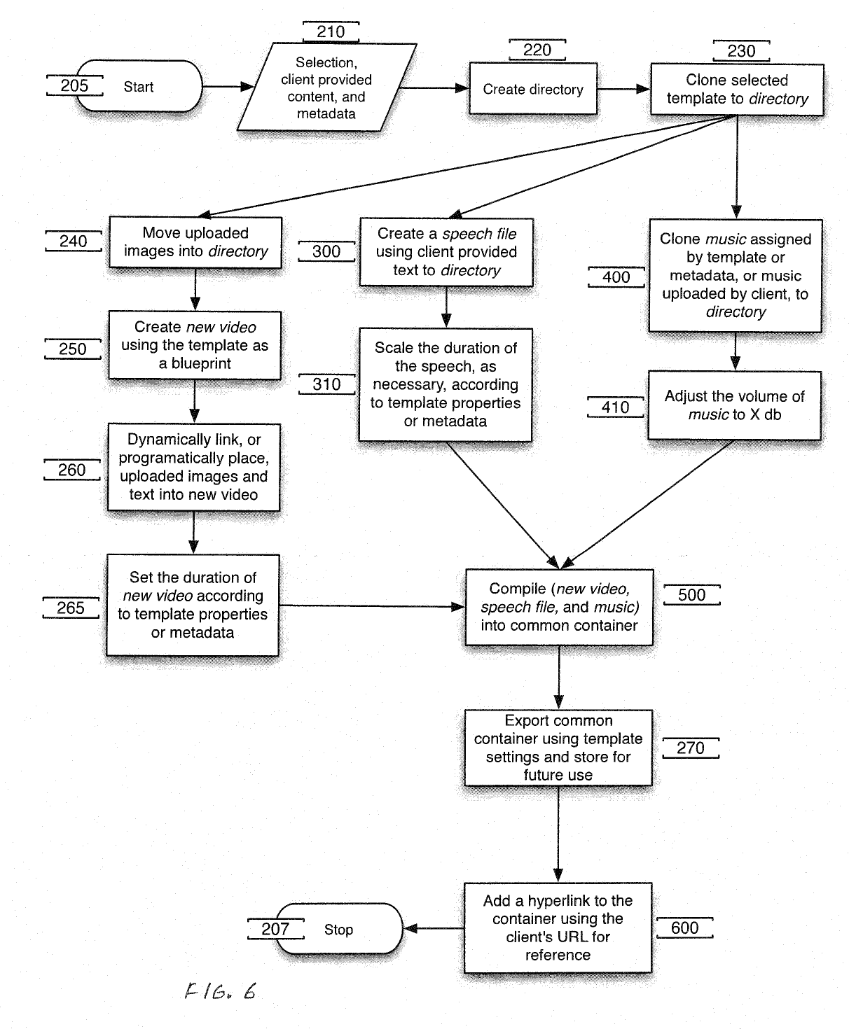

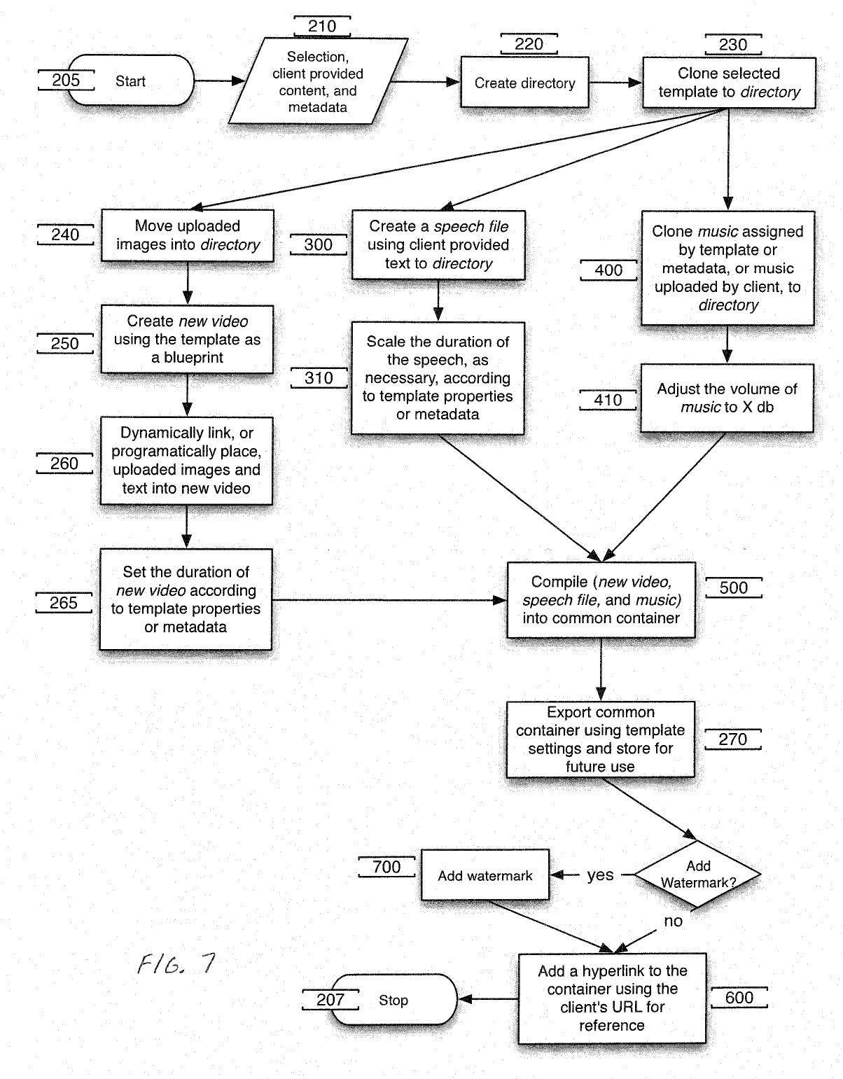

In further detail, still referring to the invention of FIG. 1, render 200 is shown in various implementations in FIGS. 2-7. Upon receipt of request to process for approval 40, grid 170 may start 205 of render 200. Grid 170 may use elements 30 provided by client 150 to enhance metadata 210. A directory 220 may be created so that the stored template selection 20 may be cloned 230 to directory 220. Grid 170 may also move images 240 contained in elements 30 to directory 220 for use in render 200, and create new video 250 using cloned template 230. Render 200 may also dynamically link or programmatically place 260 of moved images 240 with new video 250. Render 200 may optionally set the duration 265 of new video 250.

Render 200 may additionally create a speech file 300 using text contained in metadata 210, supplied by client 150 in elements 30. The speech file 300 may also be scaled in duration 310 according to data relating to duration contained in metadata 210. Render 200 may also supplement music 400 to directory 220, and may adjust the volume 410 of music 400.

Render 200 may compile 500 either the result of dynamically linking or programmatically placing 260 of images 240, or the altered duration 265, along with scaled speech 310 and volume adjusted music 410. Render 200 may then use compile 500 to export to a container 270, and save container 270.

Render 200 may further add a watermark 700 to container 270, to enable client 150 to preview 60 of render 200. Client 150 may provide a URL in elements 30, which may be contained in metadata 210. The URL may be used to create hyperlink 600 and embedded into container 270. Grid 170 may then stop 207 of the render 200 and notify application 160 that renders 200 is complete 50.

In reference to FIG. 1, client 150 may be a web browser, SOAP client, or other computer program that is capable of communication with application 160 via a network. Application 160 may be a middleware computer program that is capable of handling requests from one or many client 150 and providing appropriate responses. Application 160 may be written in a compiled language such as C or Java, or an interpreted language such as Python or Ruby. Render grid 170 may include a single computer, or a distributed set of computers, capable of performing render 200 in a procedural or threaded manner.

Stages of the render 200 may be substituted or omitted, as shown in FIGS. 2-7. Additionally, the as long as start 205, metadata 210, dynamically linking or programmatically linking 260, export container 270, and stop 207, and of the stages may be completed in any order that results in container 270.

The advantages of the present invention include, without limitation, the ability for an individual or business to create a high-quality, interactive multimedia file by selecting a template 10, providing a set of elements 30, having a grid 170 to create a render 200, and provide a final container 270 that can be linked to using a URL 120 or simply distributed via a network as a self-contained file. The container 270 may contain a speech 310, music 410, in addition to images or video. Container 270 may also contain an embedded hyperlink 600 that directs a viewer to information related to elements 30 provided by client 150.

In broad embodiment, the present invention is any template-based process which is capable of rendering a multimedia container using client supplied content, and optionally inserting audio created using text-to-speech technologies, music, and an embedded hyperlink.

In addition, user may utilize a phone such as a cell phone to call in their voice over the video, or use a microphone connected to their computer to record their voices over in browser. Moreover, a user may enter certain criteria, such as a daily budget, which may be pushed out to ad networks, such as Googles AdWords to place the resulting videos as advertisements.

While various embodiments of the invention have been described, it will be apparent to those of ordinary skill in the art that many more embodiments and implementations are possible within the scope of this invention. Accordingly, the invention is not to be restricted except in light of the attached claims and their equivalents.

What is claimed is:

1. A method of creating multimedia file creation, the method comprising:
providing a video related template;
providing a required media;
customizing a multimedia container based on the video related template and the required media; and
using an advertising network to publish the multimedia container to enable advertisement targeting.
